(19) United States
(12) Patent Application Publication
(10) Pub. No.: US 2018/0104574 A1
(43) Pub. Date: Apr. 19, 2018

(54) UNIVERSAL GAME CONTROLLER

(71) Applicant: Sean TAGER, Hamilton (CA)

(72) Inventor: Sean TAGER, Hamilton (CA)

(21) Appl. No.: 15/567,291

(22) PCT Filed: Apr. 22, 2016
(86) PCT No.: PCT/IB2016/052311

§ 371 Date: Oct. 17, 2017

Related U.S. Application Data
(60) Provisional application No. 62/152,268, filed on Apr. 24, 2015.

(51) Int. Cl. A63F 13/23; A63F 13/22; A63F 13/26

(52) U.S. Cl. CPC A63F 13/23; A63F 13/21; A63F 13/26; A63F 13/22

(57) ABSTRACT

An electronic game controller designed to be compatible with a plethora of gaming platforms/consoles and operating systems. The console in question, may be, but is not limited to, any computer based system that generates computer graphics through which a user interacts. The invention, shall communicate with the computerized system in question using any form of communication, which includes but is not limited to a universal serial bus (USB), Inter-Integrated Circuit (I2C), local area network (LAN), wireless local area network (WLAN), Bluetooth, etc. The invention shall house the ability to generate computer graphics through the use of, but not limited to, an on board liquid crystal display (LCD) of any type or derivation, a projector or a hologram. The on board graphics shall be used to allow the user to select from a list of varying communication protocols/USB drivers, thus enabling the user to interface with the desired gaming platform. The on board graphics shall allow the user to enable or disable various features, including but not limited to; accelerometers, gyroscopes, infra-red cameras, haptics, potentiometers, or any other sensor. The on board graphics shall also allow the user to bind any button/joystick command to any other button/joystick command.

### CROSS-REFERENCE TO RELATED APPLICATION

This application claims priority to U.S. provisional patent application No. 62/152,268, filed Apr. 24, 2015, the contents of which is incorporated herein by reference.

### FIELD

The specification relates generally to computing device input apparatuses, and specifically to a universal game controller.

### BACKGROUND

It is not uncommon for some users to have multiple video gaming consoles available to them. These consoles, however, rarely possess the ability to interchange components, such as games and controllers. Therefore, every console, must have it own unique controller that cannot be used on any other console. There are some consoles, such as PC computers, that allow some cross compatibility with other consoles, such as the Sony Playstation, but only in a limited capacity. To further complicate problems, there has been a recent influx of competing consoles released onto the market by Apple, Google, Amazon, Ouya and Madcatz to name only a few. These newly released consoles are sold with custom controllers that are not designed to be compatible with other consoles. Even computer game controllers are not universally compatible, since a controller that functions on a Windows operating system may not function on a Linux operating system.

With earlier systems, like the Nintendo 64 and the Sony Playstation, one of the limitations on cross compatibility was due to hardware, since the pin-out of a Nintendo 64-controller was not the same as the pin-out for a Sony Playstation controller. Recent consoles, such as the Playstation 3 and 4, as well as the XBOX 360 and the XBOX One, utilize a universal serial bus (USB) to communicate with their respective game controllers.

The emergence of additional mediums of communication between controllers and host devices is not isolated to only the USB protocol, but extends to wireless controllers. In recent years there has been a common frequency that has emerged as the dominant, the 2.4 GHz frequency. Many wireless game controllers utilize this particular frequency. However, despite the availability of the above-mentioned communication technologies, cross-compatibility between controllers and host devices remains problematic. Some vendors, for example, employ different protocols. For example, Sony has opted to use Bluetooth, while Logitech has chosen to use a USB dongle that has a custom designed protocol. Some consoles utilize their own custom protocols while others may opt for an open source solution such as ZigBee. These varying implementations frustrate cross-compatibility.

Examples of controllers that interact with multiple hosts include U.S. Pat. No. 6,288,709, U.S. Pat. No. 8,904,056; and US Pat. Publication Num. 2006/0164391. Examples of game controllers that take on the mechanical form of a gamepad, yet also contain the functionality of a mouse/keyboard are shown in U.S. Pat. No. 8,401,588. Examples of game controllers that utilize an LCD to switch between consoles are shown in U.S. Pat. No. 8,187,095. Examples of game controllers that utilize accelerometers and gyroscopes are shown in U.S. Pat. No. 8,961,312 and US Pat. Publication Num. US 2014/0323221.

Based upon the aforementioned, there is a need within the art for some manner in which varying communication protocols that share compatible hardware can interact through modified software in order to transmit the necessary data.

### SUMMARY

The present invention pertains to human interface devices designed to interact with gaming consoles/computers. More specifically, the invention pertains to the ability to switch wired/wireless communication protocols and/or USB drivers via digital/analog inputs through the use of an on board computer generated image. It also possesses the ability to enable/disable sensors while containing the ability to modify the settings and sensitivity of the communication protocols, on board sensors, joysticks and the buttons.

Embodiment of the present invention contains both digital and analog inputs, a liquid crystal display, a universal serial bus (USB) transceiver, a wireless transceiver (2.4 GHz), a lithium ion battery and a battery management system. In the proposed invention the USB/wireless transceivers are integrated into a system on chip (SOC), called a microcontroller, but development using external transceivers connected to processors is also possible.

In a preferred embodiment, a liquid crystal display, hereafter referred to as an LCD, is embedded into the housing of the game controller. The LCD can display a graphical user interface, hereafter referred to as a GUI, that displays options that the user may select from. The embodiment also houses buttons and analog inputs, such as joysticks, that enable the user to interact with the GUI.

Although the present embodiment utilizes an LCD, data may also be conveyed to the user via projectors, holograms or by any other computer generated image generated utilizing on board electrical components housed within an electronic gaming peripheral. In other embodiments, the electrical components may be external to the peripheral and connected to the peripheral.

The preferred embodiment includes a GUI that is run by software located on the embedded processor. The software in question draws all graphical pictures, icons, text, text boxes, backgrounds images and any other graphical means which facilitate interaction between the GUI and the user. The software also contains input parameters that respond to event inputs orchestrated by the user. The software responds to events input by the user in such a manner as to allow the user to turn on/off, enable/disable, tune or modify the state of the communication protocols, sensors, buttons and analog inputs.

The preferred embodiment has a software kernel located on the embedded microcontroller/s. This kernel contains all of the USB drivers and wireless protocols necessary to facilitate communication with the targeted host console/computer. The kernel is also responsible for all battery management and processing input commands that are to be relayed to the host console/computer in order to interact with the video game.

In the preferred embodiment there may be more than one microcontroller, each with their own distinct kernel. These microcontrollers may communicate with one another using any communication protocol available to them.

The proposed embodiment is designed to allow the user to access any game, on any gaming console, regardless of the communication protocol in effect, whether wired or wireless, so long as the console in question has an available USB port and/or a wireless receiver. The ability to access the game in question will be done through the GUI, which will respond to inputs by the user who may choose any available communication protocol stored in software.

The proposed embodiment includes the ability to receive new software from the host console/computer which is used to add/remove features from the GUI/kernel. These features include, but are not limited to, new USB drivers, new wireless protocols, advanced features utilized during game play, improved graphics and/or GUI functionality.

The proposed embodiment includes an LCD that will be populated with a list of communication protocols that the user may choose from, in order to select the gaming console in which he/she wishes to interact with. The user may, at any time, switch the communication protocol, by selecting values displayed on the LCD via digital/analog inputs, in order to play a plethora of games on varying consoles/computers. Furthermore, certain platforms allow the use of more than one interface, such as games which can be played on a computer with a keyboard, mouse or gamepad. The invention enables the user to choose the interface they desire.

The proposed embodiment contains the ability to not only switch between game consoles/computers, but to switch drivers within a single console/computer, it thus inherently contains the versatility to emulate varying devices. So although, the invention contains a housing that is reminiscent of a gamepad, it can nonetheless behave like a mouse, keyboard, joystick, steering wheel, keypad, or any gaming peripheral. As a result, the proposed embodiment includes options available within the GUI that allow it to turn on/off and/or adjust sensors which modify the behaviour/response of the gamepad in order to mimic the response of other gaming peripherals.

In the preferred embodiment the USB transceiver may contain the ability to process interrupt, bulk, synchronous and/or asynchronous transactions. This enables the gamepad to switch between the ability to play games and update the software inside the microcontroller/memory of the gamepad. The software update may be utilized to add more USB drivers as future development permits. So if a new USB driver is introduced onto the market any time in the future, the gamepad may be updated and the driver added to the list of drivers already present on the selection list found in the GUI. The drivers required to transfer the updated software are not limited to the human interface device class, but may extend to the mass storage device class, generic device class such as winusb or libusb, and any other USB class capable of transferring the necessary software required to perform the update.

The preferred embodiment includes a wireless transceiver with the ability to transfer data to/from the host console/computer for purposes of interacting with a given game or performing a given software update. This has the added benefit of adding wireless functionally for future communication protocols that may emerge.

Although the embodiment of the design utilizes a transceiver that transmits and receives on a fixed frequency of 2.4 GHz, this may be altered, amended or expanded to include other/multiple frequencies, such as 5.8 GHz, as well as the ability to utilize other forms of wireless communication such as, but not limited to RFID and infra-red.

The embodiment can switch between wireless protocols found on the same frequency as that which is capable of being processed by the on board wireless transceiver. The present embodiment contains a wireless transceiver that operates within the 2.4 GHz frequency spectrum. This is the same frequency utilized by Bluetooth, Zigbee, ANT and a plethora of custom protocols such as Enhanced Shock Burst and Gazelle.

Embodiments of the present invention contain buttons and analog inputs intended to allow the user to interact with any video game. At any time should the user press a button or move the analog inputs the gamepad will transmit the action via the current communication protocol.

The proposed embodiment contains options within the GUI that allow it to send computer keyboard commands via buttons/analog inputs. Furthermore, the joysticks located on the housing may be used to control a computer mouse cursor.

The proposed embodiment contains options within the GUI that allow it to replace any command sent by buttons/analog inputs by another command sent by differing buttons/analog inputs. Specific buttons may be associated with specific keys on a computer keyboard, so that should the user press a button on the gamepad the host computer will respond in a manner identical to receiving a USB keyboard scan code. Additionally, more than one key may be mapped to a single button, so that should the user press a button on the gamepad, several USB scan codes are sent to the host computer.

The proposed embodiment contains options within the GUI that allow the user to replace button/analog input commands with optional sensors, including but not limited to, accelerometers, gyroscopes, magnetometers or infra-red cameras/sensors.

### BRIEF DESCRIPTIONS OF THE DRAWINGS

Embodiments are described with reference to the following figures, in which:

FIG. 1 shows the housing of the proposed design, according to a non-limiting embodiment;

FIG. 2 shows the program flow of the kernel during start up, according to a non-limiting embodiment;

FIG. 3 shows the program flow of the GUI and how the user may interact with it, according to a non-limiting embodiment; and

FIG. 4 shows the overall interaction between the host computer/console and the proposed invention, according to a non-limiting embodiment.

### DETAILED DESCRIPTION OF THE EMBODIMENTS

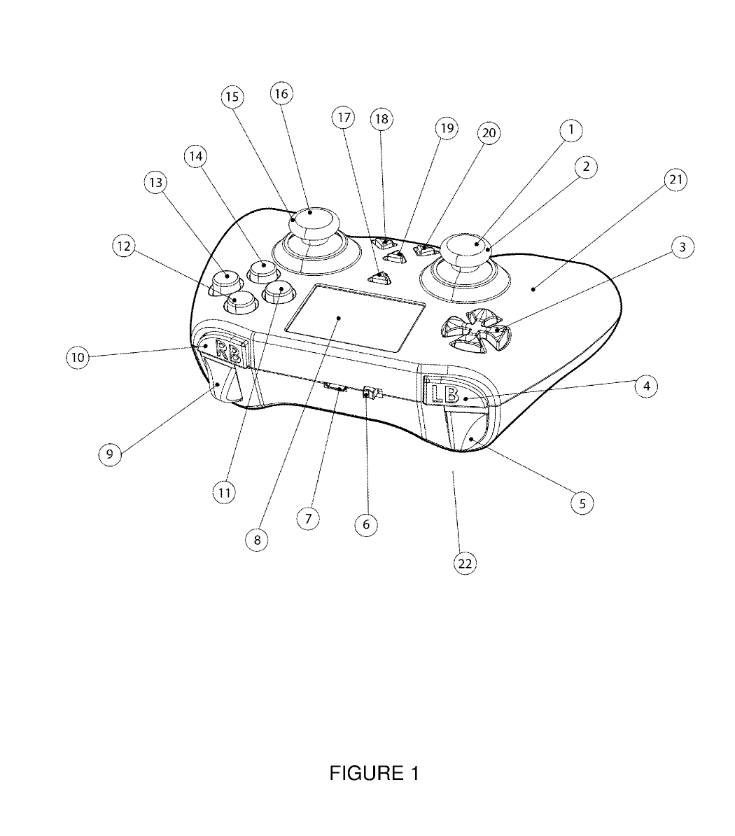

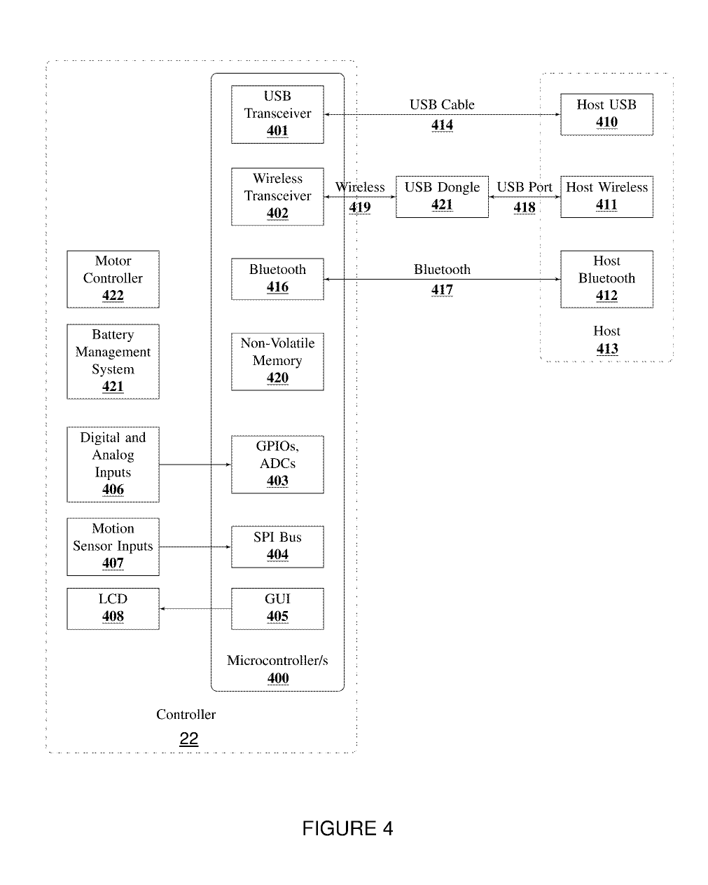

FIG. 1 shows the housing 21 of a universal controller 22, which in the present embodiment is a handheld controller. Housing 21 supports various other components of controller 22, including a plurality of input devices. In the present example, the input devices of controller 22 include a first set of buttons 11, 12, 13 and 14; a second set of buttons 17, 18, 19 and 20; at least one joystick (in the present example, two joysticks 2 and 25 are shown, which may have additional inputs such as buttons 1 and 16 thereon); a directional pad 3; trigger buttons 5 and 9; and a further set of buttons 4 and 10. Additional input devices are also contemplated, such as microphones, light sensors and the like. Other input devices can be supported inside the housing 21. For example, housing 21 can contain a PCB populated with at a processor (which in the present embodiment is implemented as the processing core of at least one system-on-a-chip or microcontroller 400 (see FIG. 4) but in other embodiments can be implemented via any other suitable processing hardware components), as well as additional input devices such as an accelerometer and a gyroscope 407. In general, controller 22 can include any of a wide variety of input devices, including either or both of analog and digital input devices.

The input devices of controller 22 (generally indicated at 406 in FIG. 4) may be connected to the processor via any suitable components, such as general-purpose input/output (GPIO) interfaces, analog-to-digital converters (ADCs) 403, serial peripheral interface (SPI) buses 404 and the like.

In some embodiments, controller 22 can include a power supply such as a rechargeable battery. In such embodiments, controller 22 can also include a battery management system 421 connected to the above-mentioned processor. Controller 22 can also, in some embodiments, include one or more vibration motors within the housing, for generating haptic feedback. In such embodiments, as shown in FIG. 4, controller 22 can include one or more motor controllers 422 connected to the processor.

Controller 22 also includes a communications interface, which can be any one of, or any suitable combination of, a wired interface such as a mini-USB port 7 connected to a USB transceiver 401, a wireless transceiver (e.g. a 2.4 GHz wireless USB transceiver 402, a bluetooth transceiver 416 or any other suitable radio hardware). The communications interface is configured to establish a communications link with a host computing device 413 (e.g. a personal computer, a gaming console, or the like). The link can therefore be established, for example, by a mini USB cable 414 plugged into mini-USB port 7 at one end thereof and, at the other end of the USB cable, into a USB port and associated controller 410 at host computing device 413. In other embodiments, the link can be established via a wireless link 419 to a wireless USB dongle 421 connected (via a USB port 418) to a host USB controller 411 at the host device 413. In further embodiments, the link can be established via a wireless link between corresponding Bluetooth (or any other suitable short-range wireless protocol) transceivers 416 and 412 at controller 22 and host device 413, respectively.

Controller 22 also includes a display 8, which may include any suitable display hardware, such as a liquid crystal display (LCD—labelled as 408 in FIG. 4), other suitable flat-panel displays, projectors, holograms or by any other component capable of presenting computer generated images generated utilizing on board electrical components housed within the controller 22. In other embodiments, the electrical components may be external to the controller 22 and connected to the controller 22.

Controller 22 can also include a power switch 6, which may be moved to the on position to turn on controller 22. In other embodiments, plugging controller 22 into host device 413 (e.g. via cable 414) may automatically serve to power on controller 22.

In general, as will be described below in greater detail, controller 22 is configured to connect to host device 413 and provide input to device 413 emulating any of a variety of controller types (e.g. game controllers such as the XBox 360 and XBox One controllers, keyboards, mice, gamepads, joysticks, mass storage devices) in any of a variety of operating environments. Operating environments are defined by the type of connection between controller 22 and host device 413 (e.g. wired or wireless communications links, USB, Bluetooth and the like), as well as the operating system of host device 413 (e.g. Windows, MacOS, Linux and the like). As such, controller 22 stores a plurality of emulation settings in a memory 420 connected to the processor. Each emulation settings includes enumeration parameter(s) and mapping parameter(s). The emulation parameters define how controller 22 will identify itself to host device 413 when establishing a connection to host device 413 (e.g. as a wireless keyboard, a wired gamepad, etc). The mapping parameters define what data controller 22 will send to host device 413 when the input devices of controller 22 are activated.

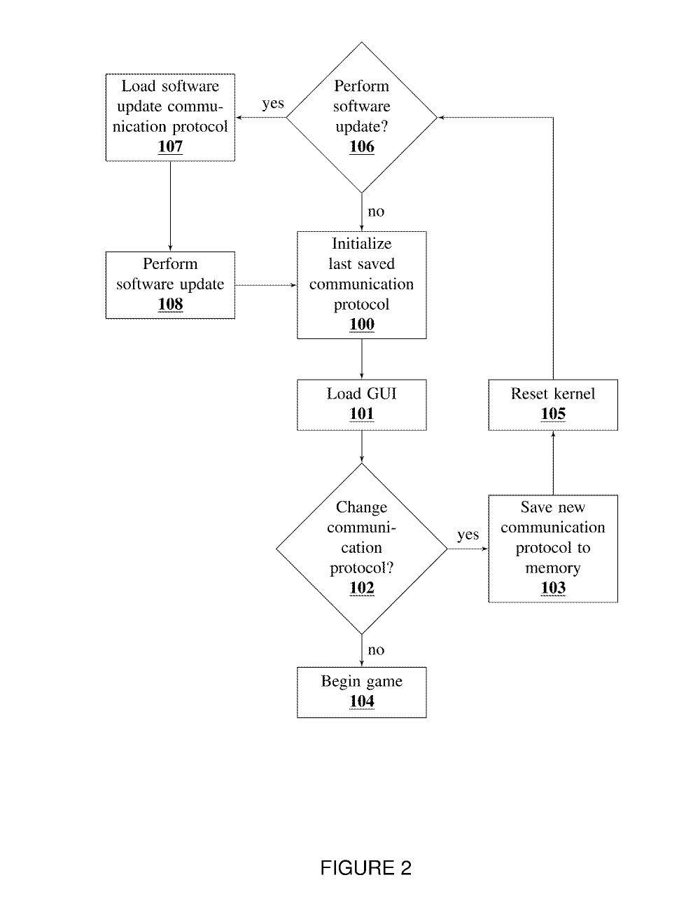

Upon receiving power, the microcontroller 400 undergoes the initialization sequence outlined in FIG. 2. Referring to FIG. 2, the initialization sequence 100 starts the kernel, which in turn retrieves the most recent user configuration saved in memory 420 as the “active” emulation setting. This configuration consists of the last communication protocol (i.e. emulation setting) in use prior to the game controller being powered down. The communication protocol is executed and thereafter a GUI 405 (which includes data and computer readable instructions enabling the processor to present various representations on display 8, as will be discussed below) is initialized 101. The user may choose to switch to another communication protocol 102 by enabling the LCD 8 and choosing another communication protocol 103. If the user does choose to load a new communication protocol then the kernel will reset the microcontroller 105 and restart the entire sequence. If however the user does nothing, then the current communication protocol will establish a link with the current host and begin transferring data 104.

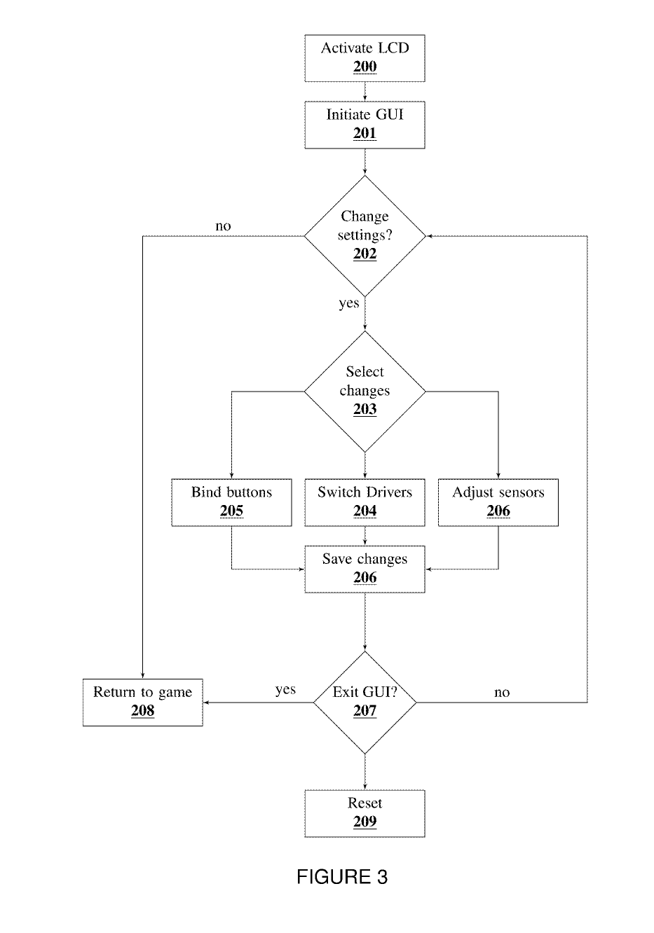

After the communication protocol has been initialized, the user may cause the controller to send commands 104 to the host computer 413 or console 413. At any time the user may press 17 and activate the LCD 8 which will initiate the control flow shown in FIG. 3. As will become apparent in the discussion below, FIG. 3 depicts a process by which blocks 102 and 103 may be performed in FIG. 2. Referring to FIG. 3, after the LCD 8 is illuminated 200, the user can navigate the list 203 by using the directional pad 3 or either of the joysticks 2 or 15. In some embodiments, display 8 can present a first level menu with selectable operating environments (e.g. a first sub-menu for selecting a communication link type and a second sub-menu for selecting an operating system, or vice-versa), and a second level menu with selectable controller types (which may be restricted based on the selection at the first level menu). Traversing the first and second level menus results in selection of one of the emulation settings.

Once the appropriate selection is highlighted on the LCD 8 the user may push 14 to execute the selection 203. This may execute an emulation (i.e. driver switching) function 204 or display a sub menu 206 which contains another list with subsequent options (e.g. tuning options for input devices 406). The user may return to the main screen 202 at any time by pressing 13. The user may navigate through all selections and eventually execute the selection by pressing 14. When the user is done making his/her selections, he/she may exit the GUI and return to the game 208 (or, if a new emulation setting has been selected, restart controller 22 to re-establish a communications link according to the newly selected emulation setting).

One of the main features available to the user consist of varying communication protocols. In this example non-limiting implementation, the user may navigate to a list entitled “Drivers” (i.e. emulation settings) 204 (upon which microcontroller 400 retrieves a list of the emulation settings (each of which, when the relevant enumeration parameters are sent to host device 413, cause host device 413 to load corresponding drivers) stored in memory 400 and presents the list to the user) and select “X Input”, which will command the gamepad to save the selection in memory 206 and perform a software disconnect of the USB 401 (or any other communications link that has been established) and terminate the connection to the host computer/console 413 at 209. Once the connection to the host device 413 is terminated, a subsequent connection will be established 100 wherein the proposed design will enumerate as a Microsoft XBox 360 controller.

The user may activate the LCD 8 by pressing 17 and navigate through the list of drivers 204 in order to load another one. This time the user may select “Emulation”, which will cause the proposed invention to perform another software disconnect and then re-enumerate as a mouse and keyboard composite device. If the host is a computer or a console that recognizes commands sent by a mouse, then the mouse cursor may be manipulated by moving either joystick 2 or 15. All other buttons on the housing 21 can be used to send key commands or mouse commands such as right and left click. For example, if the user pushes 10 the letter “t” will be sent to the host computer/console, which will react as if an actual keyboard has sent the letter “t”. The user may at any time activate the LCD 8 and use the options on screen 203 to navigate to a key-binding menu 205. This menu will enable the user to map any of the 122 keys available on a typical QWERTY keyboard to any button on the proposed design, by updating the above-mentioned mapping parameters. So the user may decide to associate the letter “r” with button 10, instead of the letter “t”. Once the button has been mapped any time the user presses 10, the gamepad will send the letter “r” to the host computer/console. This functionality also extends to the USB mouse, which contains commands for highlighting icons on a host computer desktop or activating a drop down menu that allows the user to copy, cut or paste. The user may, for example, navigate to the mouse options 205 and using the LCD 7 map the button 18 to the left button of the mouse.

In some embodiments, mapping parameters can be updated to identify several emulated inputs in connection with a single input device. For example, controller 22 can be configured to transmit, upon activation of button 14, a plurality of emulated inputs (e.g. a sequence of keyboard key-presses) rather than a single input. Mapping parameters can also identify either time-sequenced inputs or multiple simultaneous inputs.

At any time, the user may disconnect the USB cable 414 from the gamepad and pair with either a corresponding Bluetooth host 412 or a host that has enumerated the USB dongle 421. The gamepad contains a battery inside the housing 21, which is used to power the gamepad while it is not connected to the host computer through the USB port 7. The ability to switch to Bluetooth is executed by turning on the LCD 8 and navigating to the sub menu 204 labelled “Bluetooth”. Upon selecting this option by pressing 14, the gamepad will activate a Bluetooth broadcast 417. If there is a host within range, the gamepad will attempt to pair to it. The pairing may be done using HID over GATT, and may consist of any number of drivers, including but not limited to; mouse, keyboard, joystick or gamepad. This pairing may also be performed with custom designed applications incorporated into cellular phones.

The final functionality of the proposed invention is the ability of the gamepad to perform software updates 108, either through the USB port 7 or wireless 419. The user may select the option from the list of options on screen 204, which will reset the gamepad 209 and force the gamepad into state 106. From there, the user may select 11 to perform a software update 107, which will command the microcontroller to retrieve the appropriate file from the host 413 and reprogram the flash in the microcontroller. In other embodiments, software updates may be performed by downloading an update file onto host device 413 (e.g. from a server, not shown) connecting controller 22 as a mass storage device, and copying the update file onto controller 22.

The scope of the claims should not be limited by the embodiments set forth in the above examples, but should be given the broadest interpretation consistent with the description as a whole.

1. A universal controller for a host computing device, the universal controller comprising:
a housing;
an input device supported by the housing;
a communications interface supported by the housing;
a memory supported by the housing and storing a plurality of emulation settings, each emulation setting including:
(i) an enumeration parameter indicating an emulated controller type and an emulated operating environment; and
(ii) a mapping parameter defining input data corresponding to the input device;
a display supported by the housing;
a processor supported by the housing and interconnected with the input device, the communications interface, the memory and the display, the processor configured to:
present emulation setting identifiers for a subset of the emulation settings on the display;
receive a selection of one of the emulation setting identifiers;
retrieve and transmit the emulation parameter corresponding to the selected emulation setting identifier via the communications interface, to establish a communications link with the host computing device; and
responsive to activation of the input device, transmit the input data defined by the mapping parameter corresponding to the selected emulation setting identifier over the communications link via the communications interface.

2. The universal controller of claim 1, wherein the enumeration parameters of the emulation settings each indicate a different controller type.

3. The universal controller of claim 1, wherein the enumeration parameters of the emulation settings each indicate a different operating environment.

4. The universal controller of claim 3, wherein each operating environment is indicated as a communications link type and an operating system type of the host computing device.

5. The universal controller of claim 4, wherein the communications link types include a wired link type and a wireless link type.

6. The universal controller of claim 1, the processor further configured to present the emulation setting identifiers and receive the selection by:
presenting a first level menu on the display, including operating environment identifiers; and
presenting a second level menu on the display dependent on a selection of an operating environment identifier from the first level menu, the second level menu including controller type identifiers each corresponding to one of the emulation settings.

7. The universal controller of claim 6, the processor further configured to present the first level menu by:
presenting a first sub-level menu on the display, including communications link type identifiers; and
presenting a second sub-level menu on the display, including host operating system type identifiers.

8. The universal controller of claim 1, further comprising:
a plurality of input devices supported by the housing;
each emulation setting defining a plurality of mapping parameters defining input data corresponding to each of the input devices.

9. The universal controller of claim 8, wherein each of the input devices is selected from the group consisting of: a button, a joystick, a directional pad, an accelerometer, and a gyroscopic sensor.

10. The universal controller of claim 1, the processor further configured to:
responsive to receiving an input tuning command, present input tuning options on the display;
receive a selection of an input tuning option; and
update the mapping parameter based on the selected input tuning option.

11. The universal controller of claim 10, wherein the emulated controller type includes a plurality of inputs; and wherein the mapping parameter identifies a first one of the inputs;
the processor further configured to receive a selection of the input tuning option by presenting graphics corresponding to each of the inputs on the display and receiving a selection of a graphic corresponding to a second one of the inputs;
the processor further configured to update the mapping parameter to identify the second input instead of the first input.

12. The universal controller of claim 11, the processor further configured to receive a selection of a plurality of the inputs of the emulated controller type, and to update the mapping parameter to identify each of the selected inputs.

13. The universal controller of claim 1, the processor further configured to:
store the selected emulation setting identifier as an active emulation setting in the memory;
responsive to detecting an initialization sequence, retrieve the active emulation setting.

14. The universal controller of claim 1, further comprising:
a power supply supported by the housing.

15. The universal controller of claim 14, wherein the power supply comprises a rechargeable battery.

16. The universal controller of claim 15, the communications interface including a power interface for charging the rechargeable battery.
